(19) United States
(12) Patent Application Publication
(10) Pub. No.: US 2023/0392313 A1
(43) Pub. Date: Dec. 7, 2023

(54) ARRAY OF LAUNDRY WASHING MACHINES

(71) Applicant: The Procter & Gamble Company, Cincinnati, OH (US)

(72) Inventors: David Joseph CARACCI, Cincinnati, OH (US); Michael Joseph Dempsey DOYLE, Cincinnati, OH (US)

(21) Appl. No.: 18/204,453

(22) Filed: Jun. 1, 2023

(30) Foreign Application Priority Data
Jun. 1, 2022 (EP) 22176614.0

(51) Int. Cl. D06F 31/00; D06F 39/02; D06F 33/37

(52) U.S. Cl. CPC D06F 31/00; D06F 39/022; D06F 33/37; D06F 2105/42

(57) ABSTRACT

An array of laundry washing machines that includes a plurality of laundry washing machines. Each of the laundry washing machines has an operator side. A plurality of pump systems, each of which is connected to two or more washing machines, is provided. For 80% to 100% of the laundry washing machines in the array, adjacent laundry washing machines having the operator sides out of alignment from one another by less than 90 degrees are not connected to the same pump system.

### FIELD OF THE INVENTION

An array of laundry washing machines that limits the likelihood that adjacent laundry washing machines call for laundry treatment composition from the same pump system during the same interval of time.

### BACKGROUND OF THE INVENTION

There are a variety of circumstances in which multiple laundry washing machines are supplied with laundry treatment compositions by an automated system. For example, laundromats, multiunit dwellings, commercial laundry operations, and the like have multiple laundry washing machines in a single location. The multiple laundry washing machines can be integrated with a supply system for the laundry treatment composition or laundry treatment compositions. The laundry washing machines may be activated by coins, tokens, a key card, a wired controller system, a wireless controller system, mobile phone application, manually via an operator, or the like.

There are a variety of pump systems for supplying laundry treatment compositions to multiple laundry washing machines. For example some pump systems employ a single pump and a valve control and valve actuation system that can selectively deliver one of ten different products to ten different laundry washing machines, as called for by the individual laundry washing machines. For example, the ten different products may be individually designated as products one through ten. Moreover, the laundry washing machines may be designated as laundry washing machines A though J. Over a discrete interval of time, the pump can deliver product one to laundry washing machine A. After that is complete, the pump can deliver product three to laundry washing machine H. A limitation to such a system is that a given pump system can only deliver one product to one laundry washing machine at a time.

At sites in which multiple laundry washing machines are present, it is common for a single user to use multiple laundry washing machines at the same time. Moreover, it is common for a single user to start such multiple laundry washing machines within a short time interval. For example, the user may separate his laundry into two nearby machines, one machine being used for whites and another machine being used for colors. The user may then activate the nearby machines simultaneously or nearly simultaneously. If the multiple laundry washing machines are connected to the same pump system, a queuing delay can occur if the multiple laundry washing machines call for a product at the same time or if one laundry washing machine calls for a product while the pump system is providing product to another laundry washing machine. The laundry washing machines can be programmed to pause while they wait for the called for product. These delays in a laundry washing machine receiving the demanded product can increase the cycle time of laundry washing machines. Resultingly, users can be dissatisfied with the length of time that it takes to do their laundry. If the laundry washing machines are not programmed to pause and the laundry treatment cycle continues regardless of whether the called for product is delivered, laundry treatment products may not be applied to the laundry at the appropriate time. This can result in poor performance or damage to the laundry. For example bleach applied to the clothing at the wrong time can damage the laundry and fabric softening composition applied at the wrong time can result in spotting of the laundry. With these limitations in mind, there is a continuing unaddressed need for a system of laundry washing machines and pump systems that tends to reduce the amount of time that it takes for users who employ multiple laundry washing machines to do their laundry.

### SUMMARY OF THE INVENTION

An array of laundry washing machines, the array comprising: a plurality of laundry washing machines, each the laundry washing machine having an operator side from which each laundry machine is operated; and a plurality of pump systems, wherein each pump system is in fluid communication with two or more laundry washing machines; wherein for 80% to 100% of the laundry washing machines in the array, adjacent laundry washing machines having the operator sides out of alignment from one another by less than 90 degrees are not connected to the same the pump system.

### BRIEF DESCRIPTION OF THE DRAWINGS

FIG. 1 is a laundry washing machine.

FIG. 2 is an array of laundry washing machines.

FIG. 3 is a non-inventive array of laundry washing machines.

FIG. 4 is an array of laundry washing machines according to invention.

FIG. 5 is pump system.

FIG. 6 is an array of laundry washing machines.

FIG. 7A-C are plan views of a laundromat from which data about laundry washing machine use was collected and simulations were conducted on differing groups of laundry washing machines that are close to one another to determine the percentage of overlapping dosing calls, the groups differing in A, B, and C.

FIGS. 8A-C are plan views of a laundromat from which data about laundry washing machine use was collected and simulations were conducted on differing groups of laundry washing machines that are spaced apart from one another to determine the percentage of overlapping dosing calls, the groups differing in A, B, and C.

### DETAILED DESCRIPTION OF THE INVENTION

A system of laundry washing machines and pump systems for delivering laundry treatment compositions to the laundry washing machines that tends to reduce the amount of time that it takes for users who employ multiple laundry washing machines during a single time interval to wash their laundry is described herein. To provide for the desired gain in efficiency, careful attention needs to be directed towards wisely choosing which laundry washing machines are connected to which pump system.

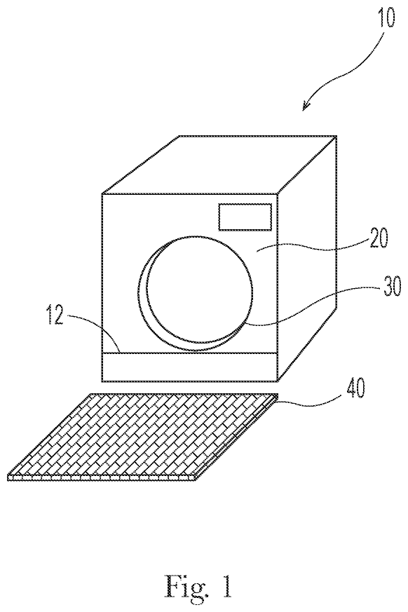

In most spaces, systems of multiple laundry washing machines are laid out in rows. In facilities having many laundry washing machines the laundry washing machines may be laid out in a rows and columns arrangement. The laundry washing machines 10 can have an operator side 20 (FIG. 1). The operator side 20 is the side from which the laundry washing machine 10 is intended to be operated by the user. For a front loading laundry washing machine 10, the operator side 20 is the side having the door 30. For a top loading laundry washing machine 10, the operator side 20 is the side facing the location where the user stands when placing or removing laundry into the laundry washing machine 10. The location at which the user stands when operating a particular laundry washing machine 10 is the operating position 40. The laundry washing machine 10 can have a width 12. The washing machines 10 can be ELECTROLUX 6000 professional washing machines. The washing machines 10 can comprise software and controllers that can communicate with the controller or directly with the pump and valves.

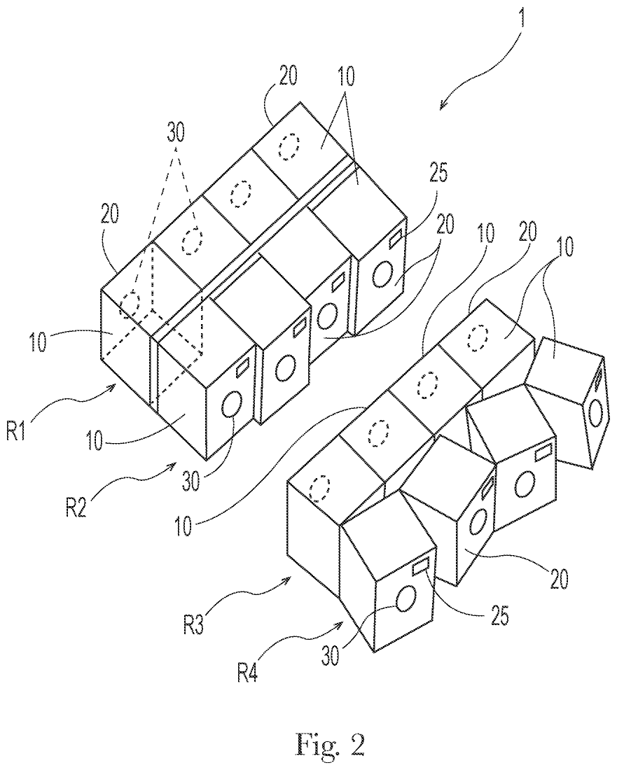

An array 1 of a plurality of laundry washing machines 10 is shown in FIG. 2. Such an arrangement might be employed in a retail laundromat, a laundry room in multiple unit dwelling, or a commercial laundry operation. Each of the operator sides 20 of the laundry washing machines 10 can be out of alignment from one another by less than 90 degrees. For example, as shown in FIG. 2, in a row of laundry washing machines 10, each of the operator sides 20 are out of alignment from one another by zero degrees, for example as shown in the rows of machines R1, R2, and R3. That is, in a row of laundry washing machines 10, each of the operator sides 20 is oriented in the same direction. If the laundry washing machines 10 in the row of machines are front loading laundry washing machines 10, the doors 30 of each of the laundry washing machines 10 in a row are each facing the same direction. The laundry washing machines 10 can be positioned so that in a row of laundry washing machines 10 the operator sides 20 are in line with one another, for example machines rows of machines R1, R2, and R3. Optionally, operator sides 20 of machines next to one another can be set forward or backward relative to one another and the operator sides 20 can be out of alignment from one another by zero degrees, as shown in the row of machines R2. Optionally, the operator sides can be out of alignment from one another by an angle less than 90 degrees, optionally less than 50 degrees, optionally less than 30 degrees, optionally less than 10 degrees, optionally less than 5 degrees, for example as in row of machines R4, in FIG. 2. Such an arrangement may help drive usage of certain pairs of laundry washing machines 10 by a single user. The laundry washing machines 10 can comprise an operational indicator 25.

Historically, users 60 were responsible for placing laundry detergent or other treatment composition into the laundry washing machine 10. Users were not wholly satisfied with such an arrangement because it required them to carry around the laundry detergent and possibly other products such as fabric softener, scent booster, bleach, stain removal composition, and the like with the load or load of laundry to be done. For a user of a laundromat, that meant that the user had to carry their load of laundry and the laundry detergent and other compositions from their dwelling to the laundromat or purchase such composition on-site at the laundromat, which was often sold at a premium cost. Moreover, requiring users to measure and dispense laundry treatment products in a laundry facility requires some time for the user and can be messy for the store operator as users may accidentally drip or spill product on the premises. In a commercial setting, the worker would similarly have to deliver laundry detergent or other composition to the laundry washing machine 10 that they were responsible for operating. The advent of pump systems for delivering individual laundry treatment compositions to individual laundry washing machines 10 has helped to overcome some of the above dissatisfaction in both multi-dwelling residential, retail, and commercial settings.

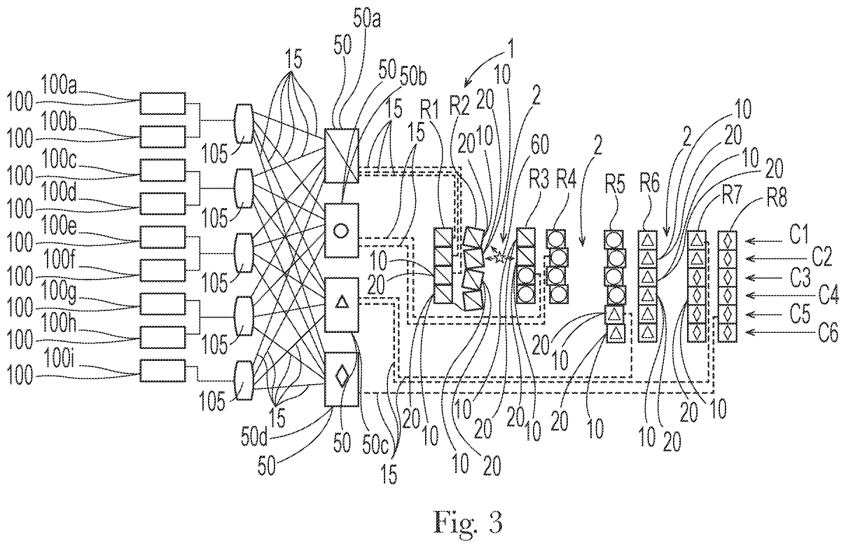

FIG. 3 is a plan view of an array 1 of laundry washing machines 10 that do not meet the claims of the invention defined herein. Each of the pump systems 50 have the ability to selectively pump a selected laundry treatment composition contained in the selected container 100 to a selected laundry washing machine 10 connected to the pump system 50. For example, the pump system 50 may be able to pump from a container 100 of laundry detergent composition, a container of fabric softening composition, and a container of bleach composition.

Each of the pump systems 50 can be in fluid communication with a plurality of containers 100. Each of the containers 100 can contain a unique laundry treatment composition. A single container 100 of laundry treatment composition can be in fluid communication with the plurality of pump systems 50. Duplicate containers 100, for example 100a and 100b (and likewise 100c and 100d, 100e and 100f, et cetera (100g, 100h, 100i) for each of different types of laundry treatment compositions provided), of a single laundry treatment composition can be provided to increase the number of doses of particular laundry treatment composition that can be provided without having replace or refill the containers 100. Such an arrangement can help reduce the time required to maintain and service the array 1.

From a plumbing layout viewpoint, it can be most convenient to layout the strings of conduits 15 connecting the pump system 50 to the laundry washing machines 10 in the spatial order of the location of the machines, for example as shown in FIG. 3. The conduits 15 connecting the pump systems 50 to the laundry washing machines 10 can be routed in a common tray in a trunk path out to the space in which the laundry washing machines 10 are provided and laterals of conduits 15 off of the trunk path can be routed to the laundry washing machines 10. The laundry washing machines 10 can be arranged in a spaced apart back to back arrangement with the operator sides 20 facing away from one another and the laterals of conduits 15 can be routed to the laundry washing machines underneath the floor or ceiling of the laundromat or laundry facility.

For example, if the pump system 50 has the capacity to connect to four laundry washing machines 10, one pump system 50 (50a) may be connected to each of the laundry washing machines 10 in row of machines R1. A separate pump system 50 (50b) may be connected to the row of machines R2. If the pump system 50 has the capacity to connect to fewer or more laundry washing machines 10 that are in a particular row of machines, once capacity of pump system 50 is reached, another pump system 50 is connected to the next laundry washing machine 10 in the layout. This approach can reduce the total length of conduit 15 needed to connect the group of laundry washing machines 10 and provide a simple layout for wiring connections between the laundry washing machines 10 and the pump system 50. In these plumbing arrangements, there is a high likelihood that two adjacent machines are connected to the same pump system 50.

This aforesaid approach to connecting the pump systems 50 to the laundry washing machines 10 can result in a poor experience for the user 60. If the user selects two side-by-side laundry washing machines 10 for use, there is a high likelihood that the two adjacent laundry washing machines 10 are connected to the same pump system 50. That can create a queuing problem if during use of the laundry washing machines 10, both laundry washing machines 10 call on a laundry treatment composition at the same time or at times overlapping with one another. Since there is only a single pump in the pumping system, the pumping system 50 can only deliver one laundry treatment composition to one laundry washing machine 10 at a time. Thus one laundry washing machine 10 or the other will have to wait for the desired laundry treatment composition to be delivered to the laundry washing machine 10. Or if the laundry washing machines 10 are not programmed to wait, the laundry treatment composition could be delivered at the wrong time of the cycle and result in damage to the laundry or poor performance of the laundry treatment cycle.

The queuing problem may be particularly acute if the user starts two laundry washing machines at the same time or closely in time with one another. Most laundry treatment cycles start with a cleaning cycle during which the drum of the laundry washing machine is filled to the desired level with water, a detergent composition is added to the drum, and the drum is agitated. In the early part of typical laundry treatment cycles, after or while water is being filled into the drum, detergent is called for by the laundry washing machine 10. The step of filling the laundry washing machine 10 may take more than one minute. A minute or more may be required to pump the called for quantity of detergent into the pump system and deliver that detergent to the laundry washing machine 10 by way of pumping or flushing with water.

If the loads of laundry are started at nearly the same time, both machines may call or be calling for laundry detergent within a common window of time. That means, that the later calling laundry washing machine 10 will have to wait to begin receiving the laundry detergent until the earlier calling laundry washing machine 10 has received the appropriate dose of laundry detergent. The later calling laundry washing machine 10 may also have to wait to begin filling with water, depending on the configuration of the array 1. These delays will add time to the cycle of the later calling laundry washing machine 10. When laundry washing machines 10 near one another are connected to the same pump system 50, there is a propensity for queuing delays to arise in the array 1 because users 60 tend to select laundry washing machines 10 near one another when more than one laundry washing machine 10 is needed by the user 60. As such, there is a high likelihood that a user 60 will select two or more laundry washing machines 10 that are connected to the same pump system 50. That, in turn, increases the likelihood that two or more laundry washing machines 10 will call on the same pump system 50 at the same time for a laundry treatment composition.

In FIG. 3, each of the pump systems 50 are connected to a plurality of laundry washing machines 10. The pump system 50 illustrated as a rectangle having a single cross hatch is in individual fluid communication with each of the laundry washing machines 10 illustrated as a square having a single cross hatch. In FIG. 3, not all of the conduits 15 connecting a pump system 50 to a laundry washing machine 10 are shown due to the overabundance of lines that would be required to illustrate each connection. For example, in FIG. 3, only three of the ten conduits 15 connecting the pump system 50 illustrated as a rectangle having a single cross hatch to an individual laundry washing machine 10 illustrated as a square having a single cross hatch are shown. In FIG. 3, each of the pump systems 50 is connected to ten laundry washing machines 10.

The pump system 50 illustrated as a rectangle having a single circle is in individual fluid communication with each of the laundry washing machines 10 illustrated as a square having a single circle. The pump system 50 illustrated as a rectangle having a single triangle is in individual fluid communication with each of the laundry washing machines 10 illustrated as a square having a single triangle. The pump system 50 illustrated as a rectangle having a single diamond is in individual fluid communication with each of the laundry washing machines 10 illustrated as a square having a single diamond.

The array 1 shown in FIG. 3 is plumbed such that laundry washing machines 10 that are adjacent to one another or near one another tend to be connected to the same pump system 50. A single pump system 50 (50a), illustrated as a rectangle having a single cross hatch, is connected to the laundry washing machines 10 starting with row of machines R1, through columns of machines C1, C2, C3, and C4, and then row of machines R2, through columns of machines C1, C2, C3, and C4, and then row of machines R3, through columns of machines C1 and C2. Likewise another single pump system 50 (50b), illustrated as a rectangle having a single circle, is connected to individual laundry washing machines 10 starting at row of machines R3, and column of machines C3, and then row of machines R4 through each columns of machines C1 to C4, to row of machines R5, column of machines C4. Likewise, the remaining pump systems 50 are connected to individual laundry washing machines advancing first by column and then by row until a pump system 50 is connected to each laundry washing machine 10.

A user 60 is illustrated in FIG. 3. A user 60 positioned as such may conveniently choose to use the three laundry washing machines 10 to which arrows are pointing. A user 60 might select one laundry washing machine 10 to launder whites, another laundry washing machine 10 to launder colors, and another laundry washing machine 10 to launder darks. Some users 60 may not separate out their laundry into different categories of laundry. Rather, they may have a large quantity of laundry needing to be washed and the quantity may be too much for a single laundry washing machine 10. The user 60 may therefore split up the load of laundry into multiple laundry washing machines 10. Users who desire efficiency tend to choose laundry washing machines 10 that are adjacent to one another. For example, the laundry washing machines 10 may be adjacent to another in a side-by-side relationship or adjacent to one another such that the operator sides 20 of the laundry washing machines 10 face one another across the aisle 2 between the laundry washing machines 10. This may be the typical user 60 behavior in a laundromat or laundry facility in a multiunit dwelling. In a commercial laundry facility, it may be labor efficient for the workers who manage multiple loads of laundry to employ laundry washing machines 10 in a similar fashion so that they minimize the time spent moving around the facility.

Consider a user 60 located as shown in FIG. 3 and illustrated as a star who has two loads of laundry to be done, one load of colors and one load of athletic apparel. For the color load, the user 60 may desire that load be laundered in a high quality detergent composition, a fabric softening composition and a scent boosting composition. For the athletic apparel load, the user 60 may desire that the load be laundered in a high quality detergent composition, a malodor treatment composition, and a scent boosting composition. If the user 60 chooses two adjacent laundry washing machines 10 in row of machines R2, each of those laundry washing machines 10 is connected to the same pump system 50 (50a). If the user starts the laundry washing machines at the same time or nearly the same time, there is a possibility that both machines will call to the pump system 50 (50a) for filling and the high quality detergent composition during the same interval of time. Thus, the later calling laundry washing machine 10 will have to wait until the earlier calling laundry washing machine 10 has been filled and received a dose of high quality laundry detergent before it can be filled and receive a separate dose of the same laundry treatment composition. Depending on the structure of the cycles of the two laundry washing machines 10 and the priority of dosing of each chemical composition programmed into the pump system 50, a similar overlapping call might occur when the scent boosting composition is called for by the laundry washing machines 10. The same or similar delays may occur if the user 60 chooses the laundry washing machine 10 located in row of machines R2, column of machines C2, and the laundry washing machine 10 located in row of machines R3, and column of machines C2, which are two adjacent laundry washing machines 10 in which the operator sides 20 face one another. The result of calls to the pump system 50 in which filling or the same or different laundry treatment compositions are called for by two different laundry washing machines 10 at the same time can result in a lengthening of the total run time for each of the laundry washing machines 10.

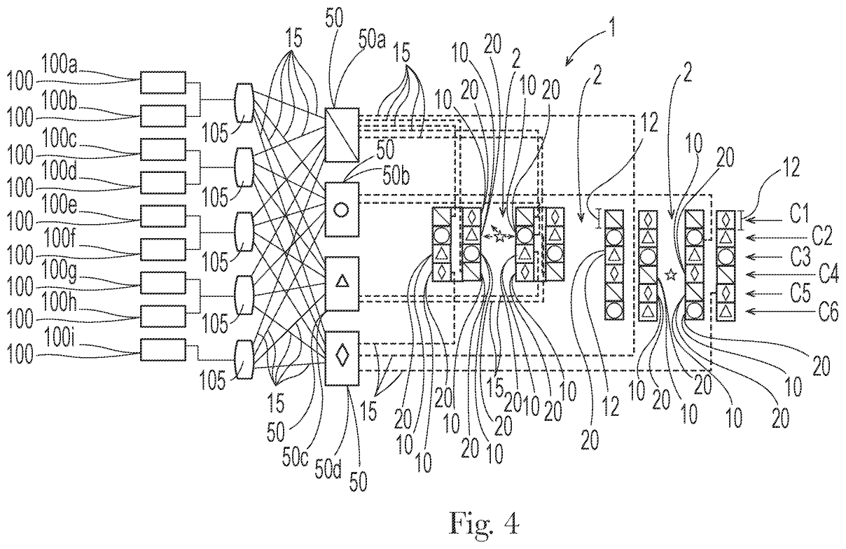

An improved approach for laying out the plumbing from the pump systems 50 to the laundry washing machines 10 is shown in FIG. 4. In such a configuration, laundry washing machines 10 that are adjacent one another tend to be connected to different pump systems 50. That will tend to result in a decreased likelihood that two or more laundry washing machines 10 call on the same pump system 50 within the same time interval.

It can be practical that for 80% to 100%, optionally for 90% to 100%, optionally for 95% to 100%, optionally 100%, of the laundry washing machines 10 in the array 1, adjacent laundry washing machines 10 having their operator sides 20 out of alignment from one another by less than 90 degrees are not connected to the same pump system 50. When 80% to 100% of the laundry washing machines 10 meet the aforesaid criteria, a large enough fraction of the array 1 is operable in a manner that sufficiently reduces the likelihood that two or more laundry machines 10 being used by the same user 60 call on the same pump system 50 for an action, such as delivery of a laundry treatment composition or filling or rinsing, within the same time interval. The more laundry washing machines 10 for which adjacent laundry washing machines 10 meet the aforesaid criteria, the greater the reduction in the likelihood that there will be overlapping calls to the same pump system 50. It can be practical to meet the condition that for 80% to 100%, optionally for 90% to 100%, optionally for 95% to 100%, optionally 100%, of the laundry washing machines 10, adjacent laundry washing machines 10 having their operator sides oriented in the same direction as one another are not connected to the same pump system 50.

In FIG. 4, in each row of machines R1, R2, R3, and R4, the operator sides 20 are out of alignment from one another by zero degrees, which is less than 90 degrees, which means that the operator sides 20 of the laundry washing machines 10 are aligned with one another and the operator sides 20 are oriented in the same direction as one another. Aligning the operator sides 20 of the laundry washing machines 10 is a particularly practical and space efficient arrangement. The operator sides 20 of laundry washing machine 10 located at row of machines R1 and column of machines C1 and the laundry washing machine 10 located at row of machines R2 and column of machines C1, which are arranged back to back, i.e. the operator sides 20 are oriented away from one another and are therefore out of alignment from one another by 180 degrees.

Adjacent laundry washing machines 10 are those that are relatively near to one another and do not have another laundry washing machine 10 between them. Relatively near can be characterized by a distance that is within four times the width 12, optionally within 3.5 times the width 12, optionally within three times the width 12, optionally within two times the width 12, of the operator side 20 of the laundry washing machine 10, width 12 being measured as the maximum dimension of the operator side 20 of the laundry washing machine 10 measured parallel to a surface upon which the laundry washing machine 10 rests. The laundry washing machines 10 can be in a side-by-side relationship in which the laundry washing machines 10 are spaced apart from one another by less than 25% of the width of the operator side 20. The side-by-side laundry washing machines 10 can be in contact with one another, spaced apart from one another, spaced apart from one another with a frame or molding between the adjacent laundry washing machines 10, or other arrangement that is functionally and aesthetically acceptable.

Adjacent laundry washing machines 10 can have their operator sides 20 facing one another. For example, laundry washing machines 10 facing one another across the aisle 2 are considered adjacent to one another, since there is not another laundry washing machine 10 between them (i.e. adjacent in the sense that there is an absence of the same thing between two things that are being considered). Such laundry washing machines 10 have their operator sides 20 out of alignment with one another by 180 degrees. The array 1 of laundry washing machines 10 can be configured such that for 80% to 100% of the laundry washing machines 10 in the array 1, no two adjacent laundry washing machines 10 in which at least parts of said operator sides 20 face one another are connected to the same pump system 50.

For a user 60, illustrated as a star, who is located at the same position as in FIG. 3, but employing the inventive array 1, as illustrated in FIG. 4, the laundry washing machines 10 that are in row of machines R2 are each connected to a different pump system 50. Moreover, laundry washing machines 10 that are in the same aisle and facing one another are each connected to a different pump system 50. This decreases the likelihood that for a user 60 who is using two or more laundry washing machines 10 at the same time that the laundry washing machines 10 will call upon the same pump system 50 during overlapping intervals of time. This will tend to reduce the total run time of the laundry washing machines 10 being used by the user 60. Reduced run time is valuable to users 60 since it reduces the amount of time they must dedicate to doing their laundry. Moreover, reduced run time increases the productivity of the array 1 for the operator. That is, more loads of laundry can be run through the inventive array 1 in a unit of time than an array 1 in which adjacent laundry washing machines 10 tend to be connected to the same pump system 50. The inventive array 1 is beneficial in that fewer laundry washing machines 10 are required to satisfactorily serve the users 60 of the laundry facility as compared to a laundry facility in which adjacent laundry washing machines 10 are connected to the same pump system 50, as in FIG. 3.

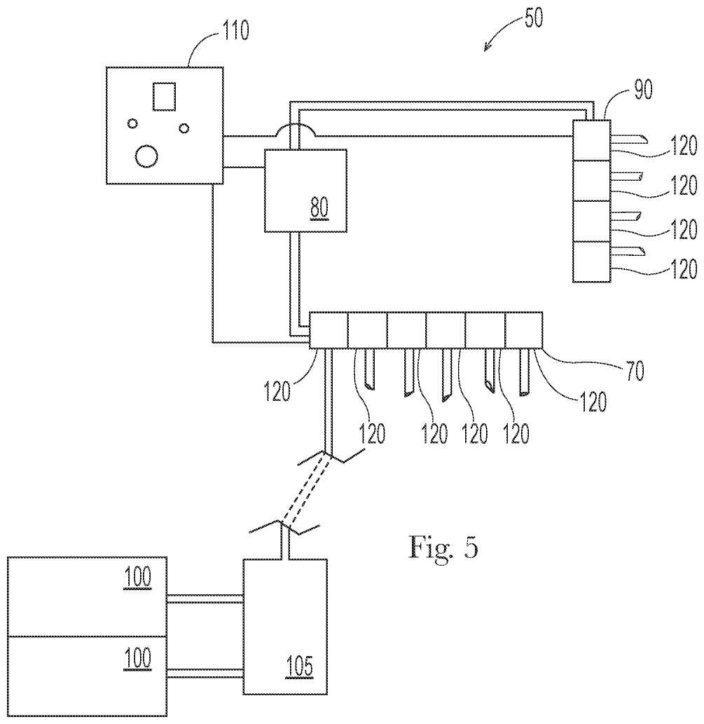

The array 1 can comprise a plurality of pump systems 50, for example as shown in FIG. 5. Each pump system 50 can be in fluid communication with two or more laundry washing machines 10. Optionally, each pump system 50 can be in fluid communication with three or more, optionally more than five, optionally six or more, optionally eight or more, optionally 10 or more laundry washing machines 10. The pump system 50 can comprise a collection manifold 70, a pump 80 downstream of the collection manifold 70, and a distribution manifold 90 downstream of the pump 80.

The collection manifold 70 can be in fluid communication with a plurality of individually contained laundry treatment compositions that differ from one another. The collection manifold 70 collects the laundry treatment composition that is to be delivered to the laundry washing machines 10. Each of the individually contained laundry treatment compositions can be contained in container 100 that is separate from the other containers 100. Optionally, an interim holding tank or junction 105 can be provided into which two or more containers 100 of the same laundry treatment composition feed into. Such an arrangement can reduce the frequency of maintenance of the array 1 and provided for a continuously available supply of a particular laundry treatment composition while an empty container 100 is replaced or refilled.

The pump 80 pumps the laundry treatment composition to the distribution manifold 90. The distribution manifold 90 operates to deliver the laundry treatment composition to the laundry washing machine 10, which is downstream of the distribution manifold 90, that is calling for the laundry treatment composition.

A controller 110 controls operation of the pump system 50. The controller 110 can be communicatively coupled with the plurality of laundry washing machines 10 to which the pump system 50 provides laundry treatment composition. The controller 110 controls opening and closing of valves 120 that form part of the collection manifold 70. By selectively opening a valve 120 in the collection manifold 70, the pump 80 can pump or draw the called for laundry treatment composition, which is contained in a particular container 100 or in or at a holding tank or junction 105. In a similar manner, the controller 110 controls opening and closing of valves 120 that form part of the distribution manifold 90. By selectively opening a valve 120 in the distribution manifold 90, the pump 80 can pump the called for laundry treatment composition to the laundry washing machine 10 making the call. A plurality of laundry washing machines 10 can be communicatively coupled to the pump system 50 so that when a laundry washing machine 10 calls for a particular laundry treatment composition, the pump system 50 can selectively open the valve 120 that permits the desired laundry treatment composition to be pumped from a container 100. The pump system 50 can also selectively open the valve 120 of the distribution manifold 90 that is in fluid communication with the laundry washing machine 10. The valves 120 can be three-way valves. The laundry washing machine 10 can also call for a certain quantity of laundry treatment composition, which is an input to the controller 110 that determines the volume of laundry treatment composition pumped to the laundry washing machine 10. The pump system 50 can comprise a flow meter by which the controller 110 can determine the volume pumped.

In operation the laundry washing machine 10 can call for a particular laundry treatment composition. In response to the call, the controller 110 can open the valve 120 in the collection manifold 70 that is connected to the container 100 or holding tank or junction 105 containing the called for laundry treatment composition. The controller 110 can also open the valve 120 of the distribution manifold 90 that connects the distribution manifold 90 to the laundry washing machine 10 making the call for laundry treatment composition. The pump 80 can then pump the desired quantity of laundry treatment composition from the container 100 or holding tank or junction 105 to a position downstream of the collection manifold 70. The valve 120 at the collection manifold 70 can then be closed. After the laundry treatment composition is pumped to a location downstream of the collection manifold 70, the valve 120 of the collection manifold 70 that connects to the container 100 of the called upon laundry treatment composition can be closed. A valve 120 of the collection manifold 70 that is connected with a water source can then be opened and water can flush the laundry treatment composition from the pump system 50 to the laundry washing machine 10 that called for the laundry treatment composition. The valve 120 connected to the water source can then be closed and the pump system 50 is ready to be called upon again to deliver a laundry treatment composition to another or the same laundry washing machine 10.

The pump system 50 can be a system such as a MULTITEC3, MULTITEC6 or MULTITEC10, available from Dositec Sistemas, Barcelona, Spain. The pump system 50 can be a system such as a MULTI-WASHER 6000 or MULTI-WASHER 10000 available from Hydro Systems, Cincinnati, Ohio, United States of America. The pump 80 can be, by way of nonlimiting example, a diaphragm pump, venturi pump, or peristaltic pump. The pump system 50 can dispense multiple laundry treatment composition to multiple laundry washing machines 10. For example, the pump system 50 can dispense six different laundry treatment compositions to ten different laundry washing machines 10.

The pump system 50 can have the capability to selectively acquire multiple laundry treatment compositions from multiple containers 100 and selectively distribute multiple laundry treatment compositions to individual laundry washing machines 10 by way of a pump 80. In the array 1 disclosed herein, multiple pump systems 50 are provided.

The array 1 can be employed to wash laundry in adjacent laundry washing machines 10 as follows. Laundry treatment composition dosing requests that overlap in time in a first laundry washing machine and a second laundry washing machine adjacent the first laundry washing machine can be initiated. In response to the laundry treatment composition dosing requests, the first pump system 50 (e.g. 50a) can deliver a first quantity of laundry treatment composition to the first laundry washing machine. The second pump system 50 (e.g. 50b) can deliver a second quantity of laundry treatment composition to the second laundry washing machine.

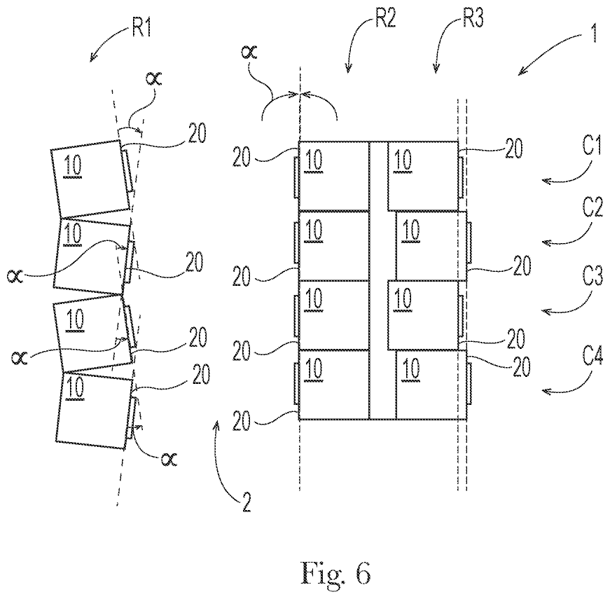

As shown in FIG. 6, the laundry washing machines 10 can be arranged such that adjacent laundry washing machines 10 have their operator sides out of alignment from one another by less than 90 degrees, optionally less than 50 degrees, optionally less than 30 degrees, optionally less than 10 degrees, optionally less than 5 degrees (e.g. rows of machines R1, R2, and R3). In FIG. 6, the angle of alignment α of the operator sides 20 is illustrated. When α is zero (rows of machines R2 and R3), the operator sides 20 can be in line with one another or oriented in the same direction as one another.

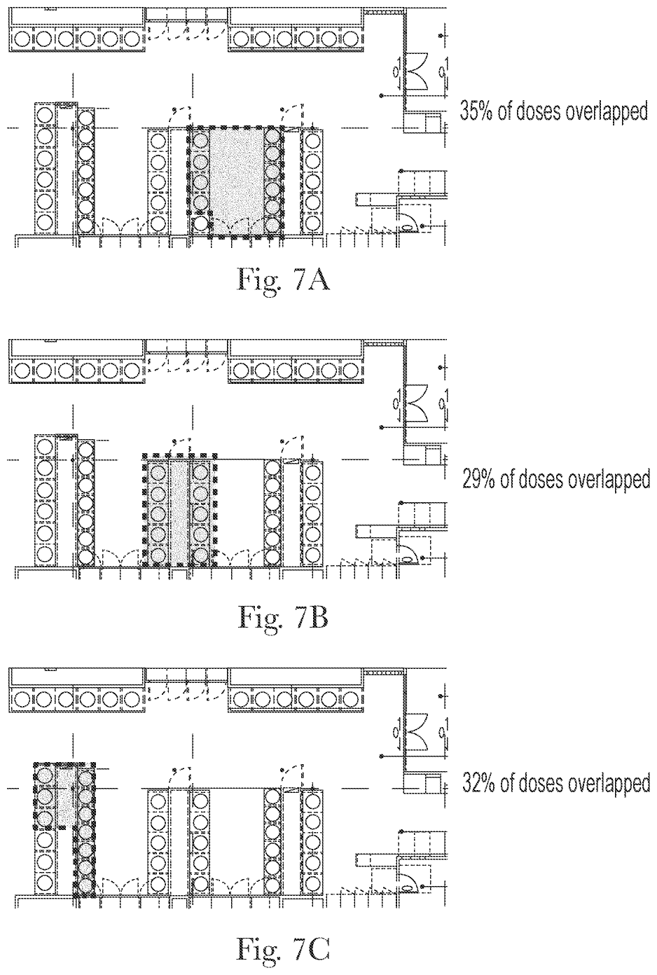

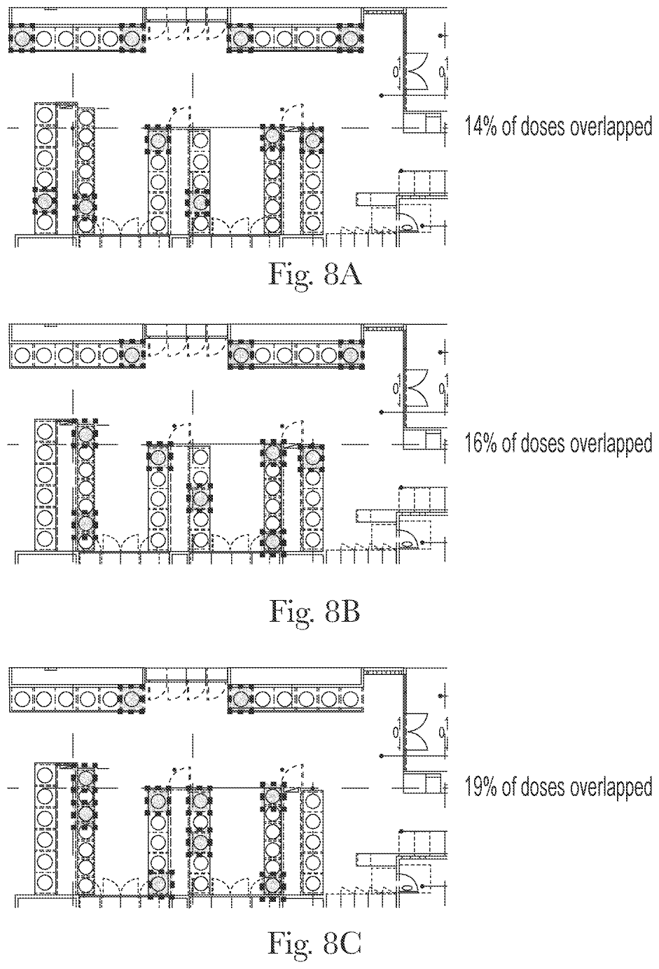

To quantify the benefits associated with configuring the array 1 such that a high percentage of adjacent laundry washing machines 10 are not connected to the same pump system 50, as claimed, data was collected in a laundromat on use of the laundry washing machines 10. The floor plan of the laundromat is illustrated in FIGS. 7 and 8. In the laundromat, a dedicated pump system 50 was provided for each laundry washing machine 10, i.e. one pump system 50 supplying to only one laundry washing machine 10. Over an approximately 14 month period, the start time of each laundry washing machine 10 having a known location in the laundromat was recorded. Over 100000 laundry wash cycles were initiated in the laundromat over this time period. Individual laundry washing machines 10 in the laundromat were used between 500 and 3900 times, depending on the location of the laundry washing machine 10.

To identify the frequency of potential overlapping calls to the pump system 50 for laundry treatment product if a dosing system 50 that supplies ten laundry washing machines 10, simulations were constructed in which groups of 10 laundry washing machines were connected to a pump system 50. The simulation was constructed so that dosing of the detergent composition began 15 seconds after the laundry washing machine 10 was started, took 90 seconds to complete the dose, and the standard deviation of the time to complete the dose was 5 seconds.

Three layouts for connecting the pump systems 50 to the laundry washing machines 10 in which each pump system 50 was connected to a group of laundry washing machines 10 in close proximity to one another were modeled (FIG. 7). In one grouping of laundry washing machines 10, ten laundry washing machines 10 in the same aisle facing each other were specified to be connected to the same pump system 50, the group being illustrated in FIG. 7A as bounded by a thick dashed line. In another grouping of laundry washing machines 10, ten laundry washing machines 10 arranged back to back to one another with a space therebetween were specified to be connected to the same pump system 50, the group being illustrated in FIG. 7B as bounded by a thick dashed line. In another grouping of laundry washing machines 10, ten laundry washing machines 10 were specified to be connected to the same pump system 50 with six of the laundry washing machines 10 being back to back to one another with space therebetween and the remaining four laundry washing machines 10 being in the same row as the three of the six aforesaid laundry washing machines 10 (FIG. 7C).

In layouts with laundry washing machines 10 grouped as shown in FIGS. 7A to 7C, 29% to 35% of the simulated dosing calls overlapped. Of the three layouts modeled, the highest percentage of overlap was for laundry washing machines 10 in the same aisle facing each other (FIG. 7A, 35% of 29,905 wash cycles, maximum queue of eight machines) Laundry washing machines 10 arranged back to back to one another with a space therebetween had a percentage of overlap of 29% (FIG. 7B, 27,195 wash cycles, maximum queue of eight4 machines). For the layout marked in FIG. 7C, the percentage of overlap was 32% (22,147 wash cycles, maximum queue of seven machines). A distinction between the groups marked in FIGS. 7B and 7C is that that the group marked in FIG. 7C has fewer laundry washing machines 10 in a side by side relationship than the group marked in FIG. 7B.

Layouts in which the laundry washing machines 10 in the group of ten laundry washing machines 10 are arranged such that adjacent laundry washing machines 10 are not connected to the same pump system 50, as claimed, are illustrated in FIGS. 8A-C. The group of laundry washing machines 10 is formed by the individual laundry washing machines 10, each of which is bounded by a thick dashed line. For the layouts illustrated in FIGS. 8A-C, only 14% (FIG. 8A, 24,008 wash cycles, maximum queue of four machines) to 19% (FIG. 8C, 30,194 wash cycles, maximum queue of five machines) of the simulated dosing calls overlapped. For the layout illustrated in FIG. 8B, the simulated percentage of overlap was 16% (27,389 wash cycles, maximum queue of six machines). In the layout illustrated in FIG. 8A, in each of the closed ended aisles, only two laundry washing machines 10 connected to the same pump system 50 are present. The remainder of the laundry washing machines 10 are separated from one another by either a large distance or face away from one another and are not likely to be started by the same user 60 within a short interval of time. In the layouts illustrated in FIGS. 8B and 8C, several of the laundry treatment machines 10 supplied by the same pump system 50 are in the same aisle as one another but tend to be spaced apart from one another along the aisle.

Another set of simulations on the layouts illustrated in FIGS. 8A-C 8 were conducted in which dosing of the detergent composition began 15 seconds after the laundry washing machine 10 was started, took 60 seconds to complete the dose, and the standard deviation of the time to complete the dose was 2 seconds. The simulated percent overlap of the layouts of FIGS. 8A-C were 9%, 11%, and 13% respectively. Decreasing the amount of time for completing the dose tended to reduce the simulated percentage of overlap.

The decrease in the simulated percentage of overlapping calls for groups of laundry machines 10 in which a high percentage of adjacent laundry washing machines 10 are not connected to the same pump system 50 is believed to provide at least two benefits. First, users 60 of the laundry washing machines 10 are more likely to achieve a short laundry cycle time since the time spent in a queue waiting for a dose of laundry product is reduced. Second, the operational efficiency of the array 1 is believed to be greater, meaning that the same number of loads of laundry can be processed over the same time period with fewer machines as compared to groups configured otherwise.

### Combinations

An example is below:
A. An array (1) of laundry washing machines, said array comprising:
a plurality of laundry washing machines (10), each said laundry washing machine having an operator side (20) from which each said laundry machine is operated; and
a plurality of pump systems (50), wherein each said pump system is in fluid communication with two or more said laundry washing machines;
wherein for 80% to 100% of said laundry washing machines in said array, adjacent laundry washing machines having said operator sides out of alignment from one another by less than 90 degrees are not connected to the same said pump system.
B. The array of laundry washing machines according to Paragraph A, wherein for 80% to 100% of said laundry washing machines in said array no two adjacent laundry washing machines in which at least parts of said operator sides face one another are connected to the same said pump system.
C. The array of laundry washing machines according Paragraph A, wherein for 80% to 100% of said laundry washing machines, adjacent laundry washing machines having said operator sides oriented in the same direction as one another are not connected to the same said pump system.
D. The array of laundry washing machines according to any of Paragraphs A to C, wherein each said pump system is in fluid communication with three or more laundry washing machines.
E. The array of laundry washing machines according to any of Paragraphs A to D, wherein for 90% to 100% of said laundry washing machines in said array, adjacent laundry washing machines having said operator sides oriented in the same direction as one another are not connected to the same said pump system.
F. The array of laundry washing machines according to any of Paragraphs A to D, wherein for 95% to 100% of said laundry washing machines in said array, adjacent laundry washing machines having said operator sides oriented in the same direction as one another are not connected to the same said pump system.
G. The array of laundry washing machines according to any of Paragraphs A to D, wherein for 100% of said laundry washing machines in said array, adjacent laundry washing machines having said operator sides oriented in the same direction as one another are not connected to the same said pump system.
H. The array of laundry washing machines according to any of Paragraphs A to D, wherein for 90% to 100% of said laundry washing machines in said array, adjacent laundry washing machines having said operator sides out of alignment from one another by less than 90 degrees are not connected to the same said pump system.
I. The array of laundry washing machines according to any of Paragraphs A to D, wherein for 95% to 100% of said laundry washing machines in said array, adjacent laundry washing machines having said operator sides out of alignment from one another by less than 90 degrees are not connected to the same said pump system.
J. The array of laundry washing machines according to any of Paragraphs A to D, wherein for 100% of said laundry washing machines in said array, adjacent laundry washing machines having said operator sides out of alignment from one another by less than 90 degrees are not connected to the same said pump system.
K. The array of laundry washing machines according to any of Paragraphs A to J, wherein each said pump system comprises:
a collection manifold (70), wherein said collection manifold is in fluid communication with a plurality of individually contained laundry treatment compositions that differ from one another;
a pump (80) downstream of said collection manifold; and
a distribution manifold (90) downstream of said pump.
L. A process for washing laundry in said adjacent laundry washing machines according to any of Paragraphs A to K comprising the steps of:
initiating laundry treatment composition dosing requests that overlap in time in a first laundry washing machine and a second laundry washing machine adjacent to said first laundry washing machine; and
in response to said laundry treatment composition dosing requests, simultaneously delivering by way of a first pump system a first quantity of laundry treatment composition to said first laundry washing machine and delivering by way of a second pump system a second quantity of said laundry treatment composition to said second laundry washing machine.

What is claimed is:

1. An array (1) of laundry washing machines, said array comprising:
a plurality of laundry washing machines (10), each said laundry washing machine having an operator side (20) from which each said laundry machine is operated; and
a plurality of pump systems (50), wherein each said pump system is in fluid communication with two or more said laundry washing machines;
wherein for 80% to 100% of said laundry washing machines in said array, adjacent laundry washing machines having said operator sides out of alignment from one another by less than 90 degrees are not connected to the same said pump system.

2. The array of laundry washing machines according to claim 1, wherein for 80% to 100% of said laundry washing machines in said array no two adjacent laundry washing machines in which at least parts of said operator sides face one another are connected to the same said pump system.

3. The array of laundry washing machines according to claim 2, wherein each said pump system is in fluid communication with three or more laundry washing machines.

4. The array of laundry washing machines according to claim 3, wherein each said pump system comprises:
a collection manifold (70), wherein said collection manifold is in fluid communication with a plurality of individually contained laundry treatment compositions that differ from one another;
a pump (80) downstream of said collection manifold; and
a distribution manifold (90) downstream of said pump.

5. A process for washing laundry in said adjacent laundry washing machines according to claim 4 comprising the steps of:
initiating laundry treatment composition dosing requests that overlap in time in a first laundry washing machine and a second laundry washing machine adjacent to said first laundry washing machine; and
in response to said laundry treatment composition dosing requests, simultaneously delivering by way of a first pump system a first quantity of laundry treatment composition to said first laundry washing machine and delivering by way of a second pump system a second quantity of said laundry treatment composition to said second laundry washing machine.

6. The array of laundry washing machines according claim 1, wherein for 80% to 100% of said laundry washing machines in said array, adjacent laundry washing machines having said operator sides oriented in the same direction as one another are not connected to the same said pump system.

7. The array of laundry washing machines according to claim 6, wherein each said pump system is in fluid communication with three or more laundry washing machines.

8. The array of laundry washing machines according to claim 7, wherein each said pump system comprises:
a collection manifold (70), wherein said collection manifold is in fluid communication with a plurality of individually contained laundry treatment compositions that differ from one another;
a pump (80) downstream of said collection manifold; and
a distribution manifold (90) downstream of said pump.

9. A process for washing laundry in said adjacent laundry washing machines according to claim 8 comprising the steps of:
initiating laundry treatment composition dosing requests that overlap in time in a first laundry washing machine and a second laundry washing machine adjacent to said first laundry washing machine; and
in response to said laundry treatment composition dosing requests, simultaneously delivering by way of a first pump system a first quantity of laundry treatment composition to said first laundry washing machine and delivering by way of a second pump system a second quantity of said laundry treatment composition to said second laundry washing machine.

10. The array of laundry washing machines according to claim 1, wherein for 90% to 100% of said laundry washing machines in said array, adjacent laundry washing machines having said operator sides oriented in the same direction as one another are not connected to the same said pump system.

11. The array of laundry washing machines according to claim 10, wherein each said pump system is in fluid communication with three or more laundry washing machines.

12. The array of laundry washing machines according to claim 11, wherein each said pump system comprises:
a collection manifold (70), wherein said collection manifold is in fluid communication with a plurality of individually contained laundry treatment compositions that differ from one another;
a pump (80) downstream of said collection manifold; and
a distribution manifold (90) downstream of said pump.

13. A process for washing laundry in said adjacent laundry washing machines according to claim 12 comprising the steps of:
initiating laundry treatment composition dosing requests that overlap in time in a first laundry washing machine and a second laundry washing machine adjacent to said first laundry washing machine; and
in response to said laundry treatment composition dosing requests, simultaneously delivering by way of a first pump system a first quantity of laundry treatment composition to said first laundry washing machine and delivering by way of a second pump system a second quantity of said laundry treatment composition to said second laundry washing machine.

14. The array of laundry washing machines according to claim 1, wherein for 95% to 100% of said laundry washing machines in said array, adjacent laundry washing machines having said operator sides oriented in the same direction as one another are not connected to the same said pump system.

15. The array of laundry washing machines according to claim 14, wherein each said pump system is in fluid communication with three or more laundry washing machines.

16. The array of laundry washing machines according to claim 15, wherein each said pump system comprises:
a collection manifold (70), wherein said collection manifold is in fluid communication with a plurality of individually contained laundry treatment compositions that differ from one another;
a pump (80) downstream of said collection manifold; and
a distribution manifold (90) downstream of said pump.

17. A process for washing laundry in said adjacent laundry washing machines according to claim 16 comprising the steps of:
initiating laundry treatment composition dosing requests that overlap in time in a first laundry washing machine and a second laundry washing machine adjacent to said first laundry washing machine; and
in response to said laundry treatment composition dosing requests, simultaneously delivering by way of a first pump system a first quantity of laundry treatment composition to said first laundry washing machine and delivering by way of a second pump system a second quantity of said laundry treatment composition to said second laundry washing machine.

18. The array of laundry washing machines according to claim 1, wherein each said pump system comprises:
a collection manifold (70), wherein said collection manifold is in fluid communication with a plurality of individually contained laundry treatment compositions that differ from one another;
a pump (80) downstream of said collection manifold; and
a distribution manifold (90) downstream of said pump.\

19. A process for washing laundry in said adjacent laundry washing machines according to claim 18 comprising the steps of:
initiating laundry treatment composition dosing requests that overlap in time in a first laundry washing machine and a second laundry washing machine adjacent to said first laundry washing machine; and
in response to said laundry treatment composition dosing requests, simultaneously delivering by way of a first pump system a first quantity of laundry treatment composition to said first laundry washing machine and delivering by way of a second pump system a second quantity of said laundry treatment composition to said second laundry washing machine.

20. A process for washing laundry in said adjacent laundry washing machines according to claim 1 comprising the steps of:
initiating laundry treatment composition dosing requests that overlap in time in a first laundry washing machine and a second laundry washing machine adjacent to said first laundry washing machine; and
in response to said laundry treatment composition dosing requests, simultaneously delivering by way of a first pump system a first quantity of laundry treatment composition to said first laundry washing machine and delivering by way of a second pump system a second quantity of said laundry treatment composition to said second laundry washing machine.
